(19) United States
(12) Patent Application Publication
(10) Pub. No.: US 2010/0161371 A1
(43) Pub. Date: Jun. 24, 2010

(54) Governance Enactment

(76) Inventors: Murray Robert Cantor, Cambridge, MA (US); Alexander Kofman, Haifa (IL); Yael Dubinsky, Haifa (IL); Tamir Klinger, Brooklyn, NY (US); Gregory Allen Rader, Yukon, OK (US); Clay Edwin Williams, New York, NY (US); Avi Yaeli, Haifa (IL)

Correspondence Address: RYAN, MASON & LEWIS, LLP, 90 FOREST AVENUE, LOCUST VALLEY, NY, 11560, US

(21) Appl. No.: 12/341,503

(22) Filed: Dec. 22, 2008

(51) Int. Cl. G06Q 10/00; G06N 5/02

(52) U.S. Cl. 705/9; 705/10; 706/47

(57) ABSTRACT

Software systems and methods for governance are presented supporting governance solution specification and enactment including assessing, defining, implementing deployment, and executing of the governance solution. For example, a software system for governance includes a governance solution model component operative to provide at least one definition and at least one semantic of at least one governance entity and a relationship of the at least one governance entity to an operational model of an organization, a governance solution editor operative to specifying a governance solution by forming a governance specification, a governance solution bundle operative to provide packaging of the governance specification into a package that can be deployed and enacted, a governance solution enactment component operative to deploy the governance solution into an organizational context, a process enactment tool operative to provide at least one configuration point, and a governance lifecycle component operative to provide a view into a state of the governance solution.

### FIELD OF THE INVENTION

The present invention relates generally to software and governance, and more particularly the invention relates to software systems applied to governance.

### BACKGROUND OF THE INVENTION

In order to be successful, development organizations are required to constantly improve productivity, control risks related to delivery time, quality, budget or regulatory compliance, and increase the generated value to the business. To realize these goals, development organizations need to be able to reflect upon the organization, processes and tools of the organization so that the organization can determine who is responsible for which actions, and which policies and measurements will ensure that effective work decisions are made. To manage these issues, the organization may implement a governance process which establishes and evolves a governance solution and constituent mechanisms of the governance solution, for example, policies, controls, measurements, and decision rights.

However, the enactment of a governance solution into a development organization context is currently a difficult manual and undisciplined task.

### SUMMARY OF THE INVENTION

Principles of the invention provide, for example, software systems and methods supporting governance solution specification and enactment, including assessing, defining, implementing, deployment, and executing the governance solution.

For example, in accordance with one aspect of the invention, a software system for governance is provided. The system comprises: a governance solution model component operative to provide at least one definition and at least one semantic of at least one governance entity and a relationship of the at least one governance entity to an operational model of an organization, a governance solution editor operative to specify a governance solution by forming a governance specification, a governance solution bundle operative to provide packaging of the governance specification into a package that can be deployed and enacted, a governance solution enactment component operative to deploy the governance solution into an organizational context, a process enactment tool operative to provide at least one configuration point, and a governance lifecycle component operative to provide a first view into a state of the governance solution.

In accordance with another aspect of the invention, a method for governance is provided. The method comprises defining a governance solution, implementing the governance solution, executing the governance solution and assessing the governance solution. Implementing the governance solution comprises designing the solution and providing the solution to the governed organization. A software system is adapted to the defining, the implementing, the executing, and the assessing of the governance solution.

Aspects if the invention enable, for example, an organization to implement and execute an automated governance process which establishes and evolves a governance solution and its constituent mechanisms, for example, policies, controls, measurements, and decision rights, throughout the lifecycle of the governance solution. For another example, aspects of the invention provide formal definition, packaging and format for a governance solution.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates a software system for governance including components of the system for governance according to an exemplary embodiment of the invention.

FIG. 2 shows a method for governance according to an exemplary embodiment of the invention.

FIG. 3 illustrates a model of a governance solution according to an exemplary embodiment of the invention.

FIG. 4 is a diagram illustrating an example of a hierarchy of governance scopes according to an exemplary embodiment of the invention.

FIG. 5 illustrates a governance platform including components of the governance platform according to an exemplary embodiment of the invention.

FIG. 6 shows an artifact life-cycle operational model according to an exemplary embodiment of the invention.

FIG. 7 illustrates a computer system in accordance with which one or more components/steps of the techniques of the invention may be implemented, according to an embodiment of the invention.

### DETAILED DESCRIPTION OF THE INVENTION

The term artifact, used in conjunction with software development, is a tangible product or byproduct produced during the development of software. Some artifacts, for example, help describe the function, architecture, and design of software. Other artifacts, for example, are concerned with the process of the software development, such as project plans, and risk assessments.

Governance is the exercise of control and direction over an entity or subject such as a society, an organization, processes, or artifacts, by using laws and/or policies that are defined, deployed, and executed. Governance, for example, controls and directs the making and administration of policy within the entity, controls and directs the actions and conducts of the entity, and influences the activities, state, or behavior of the subjects being governed. Governance is an ongoing process. Governance implies an entity with legitimate rights to exercise authority over the subject of governance.

A governance solution comprises a set of mechanisms comprising decision rights, policies, controls and measurements. The set of mechanisms is applied to a governance scope in order to achieve some governance goals.

A governance solution lifecycle is the lifecycle of the governance solution. During the governance solution lifecycle, the effectiveness of the governance solution may be measured, and corrections and alignments of the governance solution are made as necessary.

Governance entities are components of governance, for example, governance goal, scope, governance body, policy, control, and measure.

An operational model is a model that describes how an organization operates. For example, the operational model comprises process, artifacts, state transitions and user operations. The operational model provides the basic building blocks with which the governance solution can interact.

An extension point is a point in a use case where an extending use case may provide additional behavior. An extension point schema is a valid extensible markup language (XML) schema that defines a grammar that formally expresses elements, attributes, and types. This information can be used by tools to validate extensions or offer assistance during the creation of extensions.

An RACI matrix is used to describe the roles and responsibilities of various teams or people in delivering a project or operating a process. The RACI matrix is useful, for example, in clarifying roles and responsibilities in cross-functional and cross-organizational projects and processes. The RACI matrix splits tasks into four participatory responsibility types, which are then assigned to different roles in the project or process. These responsibilities types make up the acronym RACI and are: responsible, accountable, consulted and informed. Responsible are those who do work to achieve the task. There can be multiple resources responsible. Accountable is the resource ultimately answerable for the correct and thorough completion of the task. There should be only one accountable resource specified for each task. Consulted are those whose opinions are sought. Informed are those who are kept up-to-date on progress.

The invention includes aspects of a governance solution and its elements, involves defining a specification and lifecycle of the governance solution in a machine readable format, and addresses a set of interfaces needed by tools to automate the full lifecycle of the governance solution.

Existing tools have partial capabilities. Some existing tools provide configuration options for their process. Other existing tools provide an ability to define policy and enforce compliance to it. Still other existing tools provide the ability to establish a metric and track its progress.

There exists a need for a tool that defines and manages the governance solution as a whole. There also exists a need to automate the lifecycle of the governance solution, in tools, by providing well defined interfaces.

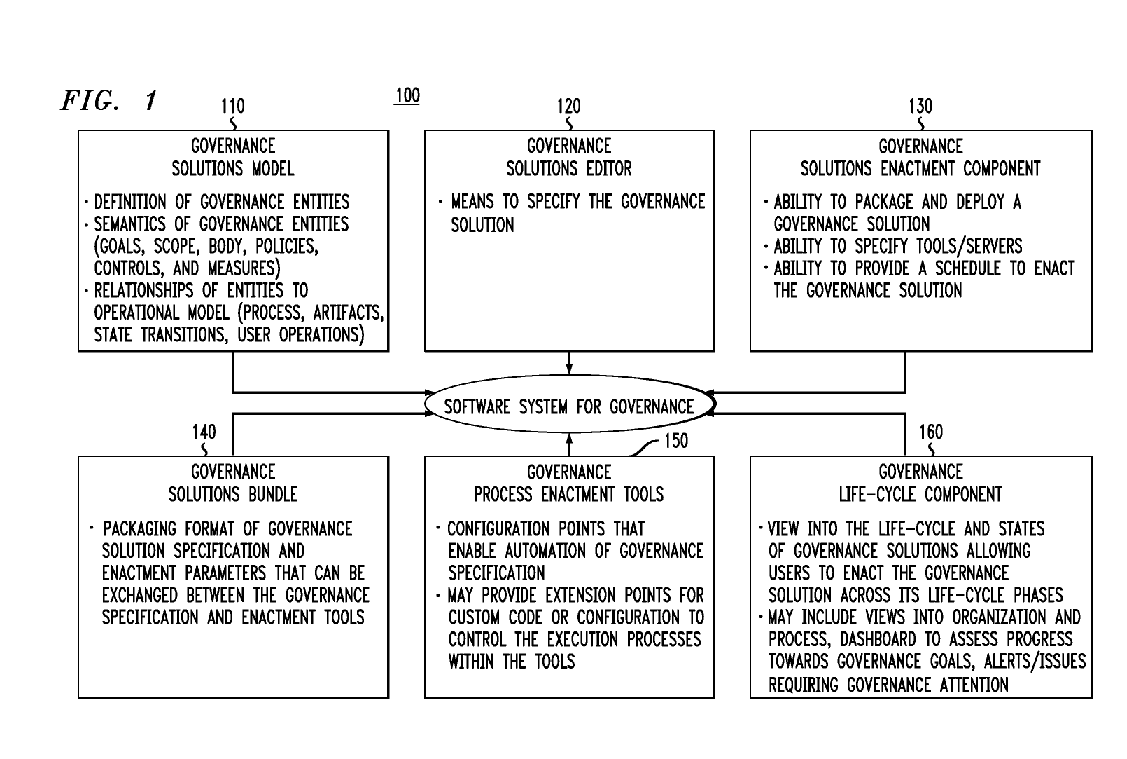

Aspects of the invention are methods, systems and tools for defining or specifying, implementing or packaging/deploying, executing, and assessing a governance solution throughout the lifecycle of the governance lifecycle. FIG. 1 illustrates a software system for governance including components of the system for governance according to an exemplary embodiment of the invention. As shown in FIG. 1, such a system comprises of the following components:

1) A governance solution model 110 providing the definition and semantics of the governance entities, for example, governance goals, scope, governance body, policies, controls, and measures. The governance solution model 110 further provides relationships of the governance entities to the operational model, for example, process, artifacts, state transitions, user operations.

2) A governance solution editor 120 that provides the means to specify the governance solution.

3) A governance solution enactment component 130 that provides the ability to deploy a governance solution into a particular organizational context, to specify tools and servers to be used for enactment of the governance solution, and to provide a schedule to enact the governance solution. The governance solution enactment component 130 enables deployment of a governance solution bundle into an organization context and/or process context.

4) A governance solution bundle 140 that provides packaging of governance specifications into a package that can be deployed and enacted. The governance solution bundle 140 provides a packaging format of the governance specification and enactment parameters that can be exchanged between the governance specification and enactment tools such as process-enactment tools, for example, providing a packaging format for providing the governance specification to an enactment tool.

5) A process enactment tool 150 that is an enactment tool that provides configuration points that enable automation of the governance specification, for example, by providing extension points for custom code or configuration to control the execution processes within the tools.

6) A governance lifecycle component 160 that provides the runtime states, history, status, and issues of governance solutions being enacted in an organization or organizations. The governance lifecycle component 160 provides a “portal” like view into the lifecycle and states of governance solutions allowing stakeholders to enact the governance solution across its lifecycle phases, for example, enact by assessing, defining, planning, implementing, deploying, or executing. The governance lifecycle component 160 may include views into organization and process, dashboard to assess progress towards governance goals and level of adoption/compliance, alerts/issues requiring governance attention, etc.

Governance is the exercise of control and direction over a subject such as a society, an organization, processes, or artifacts, by using laws and policies that are defined, deployed, and executed. This definition of governance is developed into a formal conceptual model that can be applied to a variety of governance domains. The formal conceptual model is based upon the concept of a governance solution and its lifecycle. The governance solution embodies a set of mechanisms comprising decision rights, policies, controls and measurements. The set of mechanisms is applied to a governance scope in order to achieve some governance goals. As part of the governance solution lifecycle, the effectiveness of the governance solution is measured, and corrections and alignments of the governance solution are made as necessary. The corrections are, for example, in response to assessing the governance solution. The formal conceptual model can be applied to multiple governance domains, such as information technology (IT) governance as well as software development governance.

The field of IT governance has garnered an increased amount of attention in recent years. However, the field of IT governance is still struggling to provide a universally agreed upon definition and a complete model for IT governance, along with the required tools and techniques.

Various definitions of IT governance generally share common ideas, such as the need to increase the value of IT to an organization while reducing risk. For example, by focusing on decision rights, IT governance can be defined as specifying the decision rights and accountability framework to encourage desirable behavior in the use of IT. The definition of IT governance may address the alignment of the IT organization with the business needs, and define IT governance as the leadership and organizational structures, processes and relational mechanisms that ensure that IT sustains and extends the strategy and objectives of the business organization.

A broader definition of IT governance, including both decision rights and alignment with business needs, is defining IT governance as governance that pertains to an information technology activities of an organization and the way those activities supports the goals of the business, and pertains to decision making rights associated with IT as well as the mechanisms and policies used to measure and control the way IT decisions are made and carried out within the organization.

IT governance and control frameworks help business management, IT management, quality practitioners, and auditors partially understand what needs to be done for IT governance; however, existing IT governance and control frameworks do not present complete solutions for IT governance. For example, IT governance and control frameworks may be a high-level framework targeted at IT organizations that support a business unit or a business organization and may consider software development activities only within the context of providing a supporting service in a value chain for another business unit, rather than as a central business activity in and of itself. For another example, IT governance and control frameworks may lack a description of governance mechanisms that are appropriate for organizations with a large focus on software development. To that end, organizations need to refer to other standards and frameworks that focus more on software development and control of software development activities.

Features of the invention, for example, bridge the gap between high-level IT governance and software development governance.

Consider a governance model. The purpose of a governance model is to uniformly represent the main concepts involved in a governing process and their inter-relationships. The governance model attempts to abstract the elements of governance found in the various domains. The governance model reflects a view of how governance and governance processes are organized.

The governance model describes, for example, the boundaries of the subjects and activities being governed, as well as the boundaries of the area of jurisdiction over which the governing entity will have legitimate authority. Furthermore, it is known that people are subject to multiple governing bodies, such as national and local governments, as well as the organizations where they work. The governance model describes, for example, multiple authority hierarchies and the relationships across these levels.

A governance scope represents a set of entities and relationships that is subject to acts of governance. Governance scope is hierarchically decomposable so that it can capture the hierarchical nature of society and business organizations. However, in order to represent multiple overlapping hierarchies, a governance scope can belong to more than a single hierarchy. In principle, a scope can identify organizations, sub-organizations, processes, activities, roles, and artifacts; it can then establish the boundaries over the entities that are governed. In the context of corporate governance, the scope would be the entire organization and its activities. In the case of IT governance, the scope would be the IT organization, processes, activities, roles, and resources. It is often useful to express the scope of governance in terms of processes within organizations, since there are many existing standards that consistently decompose the entire activities of organizations into processes and activities.

A governance or governing body, sometime referred to as the government, represents the set of roles that has the right to exercise authority over the governance scope. Within social and business organizations, it is common to find multiple governing bodies, each of which focuses on different governance scopes and is concerned with different governance needs. It is therefore useful to think about the arrangement of governing bodies in hierarchies and to align the governing bodies with the hierarchies of governance scopes. By doing so, the delegation of legitimate authority between governing bodies across the organization hierarchy can be expressed, and the fact that legislation enacted by one governing body needs to conform, or at least not conflict with, legislation done by another governing body higher in the governing hierarchy chain. For example, a local government cannot create laws that violate national and federal laws. Within business organizations, it is common to find a hierarchy of governing bodies based on an organizational structure. Process owners, who are given authority to exercise control and legislation within the scope of their processes, may also be considered as governing bodies.

Consider goals of governance. The purpose of governance is, for example, to influence the activities, state, or behavior of the subjects being governed. The need to influence the subjects in the first place often stems from external forces that place constraints or requirements on the activities within the governance scope. For example, state government regulations place constraints on organizations that do business within the jurisdiction of the state. Another example is the need to establish or update service delivery policies based on new security policies established by the larger organization. A final example is an IT organization that needs to control costs or improve performance based on business needs.

Hence the context of governance represents the overall situation and set of internal and external relationships in which a governance scope exists and in which its activities take place. The context sometimes acts as the driver or source of requirements for the act of governance.

A governance goal represents the desired state that an initiative or act of governance is trying to achieve within the governance scope. A goal needs to be measurable and provide a clear indication of how success and failure will be assessed. Governance goals are hierarchically decomposable, allowing the nesting of sub-goals. In this case, the success criteria of a high-level goal can be expressed as functions of the success criteria of the sub-goals. An example of a governance goal in business organizations is “ensuring that the organization performs effectively and efficiently against the requirements and imperatives coming from its context, and to ensure the delivery of the expected outcome.” It is useful to express the governance goals in the terminology of the context; this enhances the communication between different stakeholders by providing a common vocabulary.

Consider governance mechanisms. Based on the definition of governance, governance requires the means to control, direct, or strongly influence the actions and conduct of the governed subjects. A governance mechanism represents the possible mechanisms that can be used to regulate, influence, or control the actions and conduct of elements described within the governance scope in order to achieve some governance goal. There are many kinds of governance mechanisms. Examples of categories of mechanisms are: decision-making structures, process alignment, communication mechanisms, mechanisms to control processes, and mechanisms to identify policies, procedures, practices, and organizational structures as means of control. Two major groups of mechanisms that are established in the governance process are static mechanisms and dynamic mechanisms. Examples of static mechanisms are chains of responsibility, authority, and communication (decision rights). Examples of dynamic mechanisms are measurement, policy, standards, and control mechanisms. Following are several examples of these mechanisms and how they influence the governance scope.

Decision rights mechanisms are the means through which an organization can establish, charter, and communicate the roles and responsibilities for particular management and decision-making processes. Typically, the decision rights are documented and communicated in a policy, such as a spending policy that allows a first-line manager to approve spending up to $3000 without a senior manager's signature. A RACI matrix is an example of a structured way to describe decision rights.

Policies, procedures, guidelines, practices, and standards mechanisms all instruct the subjects under governance at varying level of formalism and strictness of the desired behavior or how to conduct their activities. Controls, measurements, and decision authority are often documented and communicated in policies and procedures.

Control and measurement mechanisms provide the means for people with decision-making rights to control and monitor the activities for which they are responsible. Decision checkpoints, incentives, and policy assertions are examples of controls. For example, a project funding approval checkpoint is a control in the project funding process. A return-on-equity (ROI) measurement is a mechanism used to measure the return of investment in an asset. Another example is the measurement of estimated versus actual development time for software development tasks. Note that measurement may have a dual role. For example, measurement enables monitoring but may also acts as an influencing mechanism that drives the behavior of the subjects.

The governance mechanism should provide a clear statement of its desired effect on the governance scope via one or more governance goals. Furthermore, governance mechanisms can be hierarchical, allowing governance goals to be met by a hierarchy of governance mechanisms. A governance mechanism affects a governance scope to realize a governance goal. In addition, a hierarchy of governance goals can be realized by a hierarchy of governance mechanisms.

Consider governance points and observables. In order for a governance mechanism to control and monitor an activity within the governance scope, it is necessary to identify the exact situation in the governance scope and the exact condition under which the governance mechanism should operate. This identification also serves as the specification for how to implement and deploy the governance mechanism. A governance point represents a specified location and situation within the governance scope to which a governance mechanism should be applied. For example, a policy that enables a first-line manager to approve vacations that do not exceed two consecutive weeks creates a governance point. This point is the set of situations in which first-line managers in the governance scope should decide upon vacation approvals.

From an operational perspective, it is useful to express governance points in the context of artifact lifecycles, where events, activities, and state transitions of the artifacts act as potential points to which governance mechanisms can be applied. This creates a common structure for the definition of governance points. It also supports the implementation and integration of the governance mechanism into the processes and software automation of the activities described in the governance scope.

A governance observable represents a metric, event, piece of information, or artifact metadata that can be observed by a governance mechanism at a governance point. This provides the means to characterize the behavior of the governance scope by identifying observable information that could be used to help achieve the governance goals. It also allows the identification of specific properties within the governance scope that are relevant to achieving a governance goal. For example, such properties may include an event or attribute that are used for calculating a metric.

Consider the governance Solutions and the governance process. So far we have shown how governance mechanisms can be associated with governance scopes to achieve governance goals. Often, a set of mechanisms, scopes, and goals collectively have some significance from the perspective of an organization, process, or initiative. In such cases, it is useful to refer to them as a group. A governance solution represents the collection of governance mechanisms applied to a set of governance scopes to achieve a set of related governance goals. For example, an IT governance solution is the set of governance mechanisms that are applied in the scope of an IT organization, its processes, and activities, to achieve the IT governance goals. Note that the term governance solution is commonly used to denote the specification of the mechanisms, scopes, and goals. However, as we discuss below, a governance solution has its own lifecycle and it is necessary to discuss the state of the solution at specification time as well as at other phases of its lifecycle.

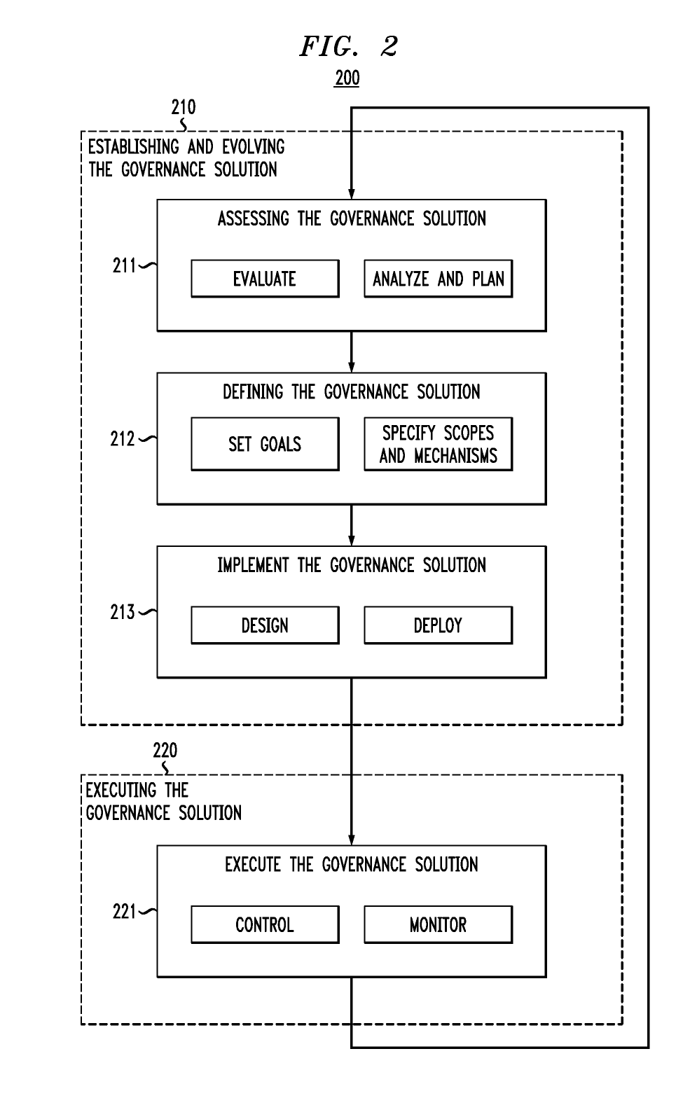

As presented in the definition, governance is an ongoing process. Governance is an iterative process through which the governance solution is established and evolved. In FIG. 2, a method for governance 200 is presented. The method for governance 200 shows the lifecycle of a governance process as well as typical activities that are likely to take place in each phase of the lifecycle. The method for governance 200 comprises the separate major activities of establishing and evolving a governance solution 210 and executing the governance solution 220.

The method for governance 200 comprises four major phases or steps. The phases or steps are assessing 211, defining 212, implementing 213 and executing 221. The major activity of establishing and evolving a governance solution 210 comprises the steps of assessing 211, defining 212 and implementing 213. The major activity of executing a governance solution 220 comprises the step of executing 221.

During the step of assessing 211, the current governance solution is evaluated and new requirements for the governance solution are analyzed and planned, including measuring governance effectiveness metrics, assessing key performance indicators against previously defined governance goals, and planning how to address new governance needs arising from the context, such as new regulations.

During the step of defining 212, the governance solution is defined. The governance goals are captured and governance effectiveness measurements are defined. The scopes to bring under governance are determined and the governance mechanisms are specified.

During the step of implementing 213 the activities, e.g., design activities, necessary to realize a defined governance specification and prepare the governance specification for execution by the organization are performed. The step of implementing 213 comprises, for example, design activities for the process and implementation, process re-engineering, automation and tool support, education, infrastructure deployment, policy announcement, and so forth. The step of implementing 213 further comprises deploying the solution in, or deploying the solution to, the governed organization.

During the step of executing 221, the solution has already been deployed in the governed organization and management is expected to execute the governance solution. Managers and other specified roles are exercising their decision rights and playing a role in controlling and monitoring the scopes under their responsibility.

In FIG. 2 the steps of the method for governance 200 are shown in an exemplary order. Other orders are possible. The steps of the method for governance 200 may be executed, in the illustrated order or in a different order any number of times. A lifecycle of the governance process comprises one pass through the steps of the method for governance 200, for example, as shown in FIG. 2. The method for governance comprises, for example, any number of lifecycles. A typical entry point into the lifecycle is activity of analyzing and planning within the step of assessing 211.

The method for governance 200 and governance lifecycle shows a clear separation between activities done to establish and evolve a governance solution and those that are done while executing a governance solution. This separation can be useful for understanding the relationships between the roles of governors and managers. Typically, governors are responsible for establishing a governance solution while managers are responsible for executing the governance solution. Moreover, a governing body will sometimes assign decision rights to itself. In those cases, the governing body is also an actor in the execution of the governance solution. Similarly, some managers may sit in governing bodies; in those cases, they assume multiple roles of both governor and manager.

The governance solution can be viewed as having states that correspond to the steps within the method for governance 200. In each iteration of the lifecycle, the method for governance 200 can modify an executing governance solution by defining, implementing, and deploying a new version of that solution. Furthermore, some activities of the step of assessing 211 may be running continuously by monitoring the executing governance solution.

A governance execution result represents the result of applying a governance mechanism at a particular time. It is a measurement that relates to the governance scope, but is used in the context of the step of assessing 211. Examples of such measurements are compliance records/status or governance performance indicators.

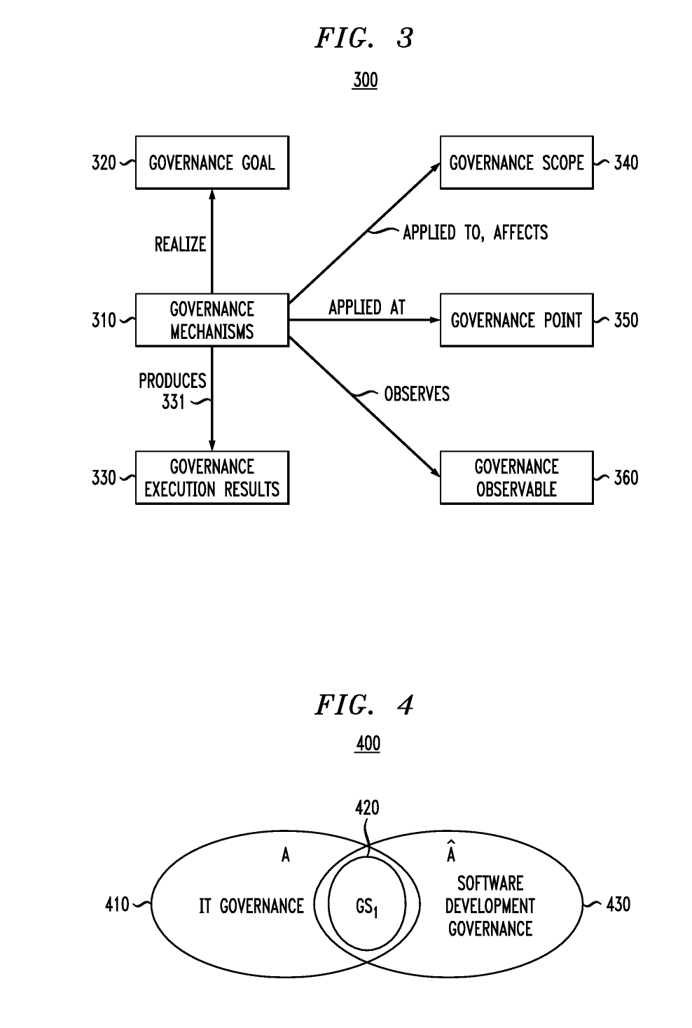

FIG. 3 illustrates a model 300 of a governance solution. A governance mechanism 310 can be used to applied to and affect some behavior within a governance scope 340 to realize some governance goal 320. The governance mechanism 310 can be applied at specific governance points 350 within the governance scope 340 to affect or observe some governance observable 360 or behavior within the scope. The result of applying the governance mechanisms 310 produces and may be stored in a governance execution result 330.

Consider systems of governance solutions. There is a proliferation of governance solutions established by multiple governing bodies to cover a wide range of governance scopes. How governance solutions are related and how the solutions can be orchestrated to scale up when governing a large organization is addressed

There are multiple governance processes that are executed asynchronously by different governing bodies. Each has its own lifecycle and the governance solution of different governing bodies can be in different states. Furthermore, the cycle time may not be the same in all governance processes. For example, some processes may have a one year cycle, while others have a quarterly cycle, depending on how adaptive and responsive the governance should be to the changing scope and context.

Governance solutions have relationships. For example, governance decisions made by a large organization may have an effect on the governance solutions established for smaller organization scopes. In fact, the former can be viewed as part of the context of the latter. For example, a larger organization can define a policy stating that all sub-organizations should be certified within two years. This imposes a requirement for each organization to initiate a governance solution focusing on certification.

Governance solutions can be defined for varying granularities of scope. For example, governance solutions that are established by the board of directors and apply to an entire organization may coexist with a governance solution that focuses on development policies for a thirty-person project.

To summarize, while the governance solution can autonomously execute for any given scope and goal, it can also link to other governance solutions either through the context or by establishing governance mechanisms that affect other governance solutions. These two characteristics ensure the scalability of the governance model.

FIG. 4 is a diagram 400 illustrating an example of hierarchy of governance scopes. A governance scope is denoted by GS₁ 420. FIG. 4 schematically shows scope GS₁ 420 as an inner scope, that is, scope GS₁ is in two different organizations, organization A and organization Â. In organization A, scope GS₁ 420 is part of the IT governance 410. In organization Â, scope GS₁ 420 is part of the software development governance 430.

Consider governance points and observables as part of the governance lifecycle. The notions of governance scope, governing body, governance goals, and mechanisms are part of the step of defining 212 and the step of implementing 213 of the governance solution and the governance solution lifecycle. The governance points and observables exist in the execute phase.

Following are governance mechanisms that provide observables data. A first mechanism is the measurement of estimated time to perform tasks of daily completed tasks versus the actual time that was invested to perform the tasks. A second mechanism is the policy of conducting a retrospective after each lifecycle iteration and before planning the next lifecycle iteration. A third mechanism is measuring team velocity, which is the amount of productive work units per iteration. Data on team velocity and retrospective processes can be presented as governance observables that are activated in the execute phase and are used as part of the assess phase of the governance lifecycle.

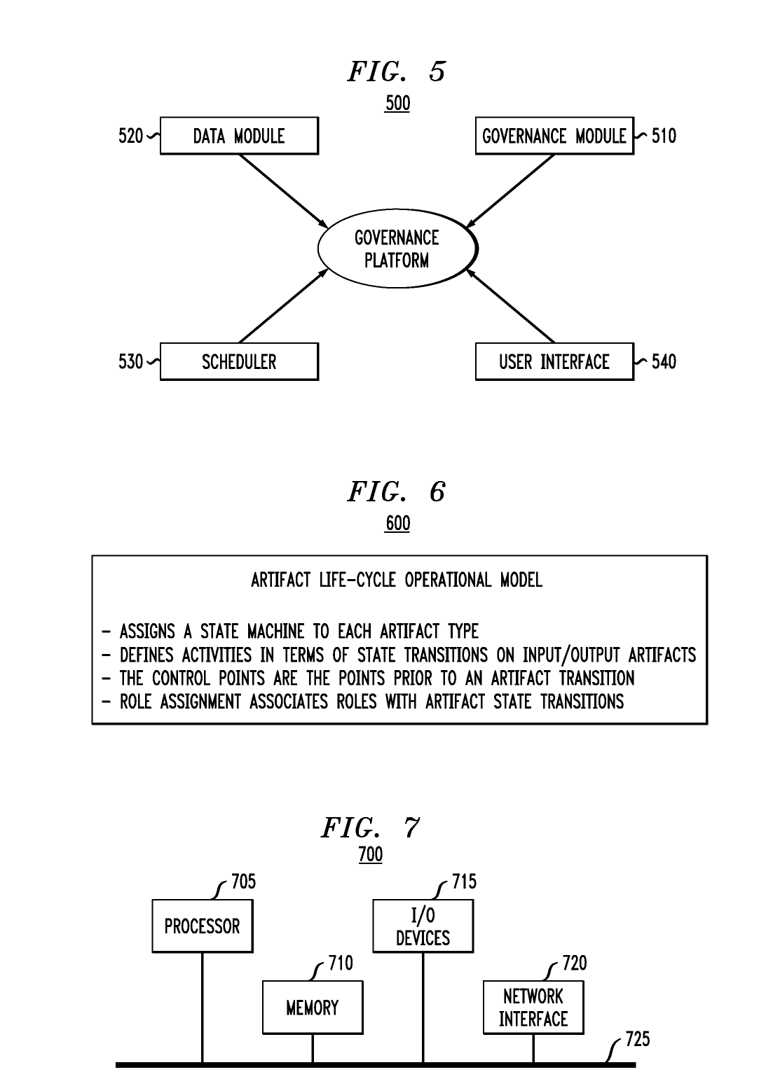

An aspect of the present invention is a governance platform based on the governance model presented herein. FIG. 5 illustrates the governance platform 500 including components of the governance platform 500 according to an exemplary embodiment of the invention.

The governance platform 500 serves as a single point of administration for the governance of software development activities. The main parts of the governance platform are the governance module 510, the data module 520, the scheduler 530, and the user interface 540.

The governance module 510 manages the governance lifecycle by supporting the governing body and relevant roles. The data module 520 contains a data adapter that mediates between the application and the database. The database includes all the information from the different data sources available in software development environments. Software development artifacts such as code, test, specifications, models, and bug list are included. Software management artifacts such as task plans and estimation graphs are also included. Activity indicators that capture the state of the activities and tasks being performed are also included. Governance observables such as measures, policies, decision rights, and roles are also included.

The scheduler 530 is responsible for scheduling tasks for governance mechanisms that are used within the governance solution.

The user interface 540 presents views appropriate to each of the different roles that are involved in the governance process.

In association with the governance platform, another aspect of the present invention is a development component of existing governance tools according to the governance model of the invention.

The concept of responsibility assignment and its use as a governance mechanism in a software development environment is presented. Common representations of responsibility assignments, responsibility assignments relationship to the operational model of software engineering and the semantics required to automate responsibility assignments enactment in development tools are reviewed.

IT governance has attracted increasing attention in many organizations. There is a growing realization that IT efforts need to be kept well-aligned with business objectives if the business is to successfully extract value from the IT organization. For development organizations, the goals of governance include increasing predictability, value realization from software projects and the management of risk and change. Tools and automation have a major role in supporting governance by increasing efficiency, accountability, and compliance with the governance solution.

Definitions for IT governance have led to a domain neutral model for articulating the governance elements. At the heart of the model lies the governance solution which embodies the set of governance mechanisms that influence a governance scope in order to realize some governance goals. For a governance solution to be effective, it needs to be implemented and deployed in the organizational context. Changes to organizational structures, processes, policies and tools may be required.

Consider responsibility assignment. One of the main governance mechanisms is the establishment of responsibility or role assignments, that is, the roles and their responsibilities for decision-making processes in an organization.

IT governance has been characterized as addressing the “what”, “who” and “how” of decision making. What decisions must be made to ensure effective management and use of IT? Who should make these decisions? How will these decisions be made and monitored?

Responsibility assignment concerns mostly who will make the decisions and, to some degree, how they will be made. Responsibility assignment details the roles responsible for a decision, their decision rights and other roles with whom they must interact. In some cases, a role will have absolute rights to a decision. In other cases, the rights are conditional on a policy or agreement.

There are various ways of representing role assignments, for example, the use of RACI matrices for documenting the roles and responsibility assignment for team members or stakeholders for performing activities. A matrix is constructed with activities down the rows and roles across the columns. The entries may contain one or more of R, A, C, or I. An “R” entry for (role, activity) indicates that role is responsible for the activity. For example, we might have a row for “deliver work item” and a column for “developer” with an entry of “R”. Later variations of the RACI matrix, such as RACI-VS and others, added relationships for verify, sign off, assist, and support. The RACI-VS construct may be modeled in a responsibility assignment map that can be attached to a process, activity, and work product elements.

The intended semantics of various RACI matrix or diagrams differ slightly depending on the source, but the diagrams all capture the different parts played by the associated role in the execution of the activity. For various RACI diagrams, the granularity of the activities may vary considerably. To be amenable to enactment by tools, the granularity of activities must be relatively small and they must be formalizable in terms of an operational model.

The RACI representation also requires extension to support the notion of a conditional decision right. In the above example, the conditional delivery rights of the developer can be represented as a guard condition on the RACI entry for the developer and the code delivery activity: currentDate <codeFreezeDate.

The kinds of conditions allowed depend on the operational model of the implementing tool and the data available at runtime to evaluate the condition.

Consider enacting responsibility assignments. Enactment is the implementation and execution of the governance solution in the organizational context. Enacting a governance solution requires making changes to the organization, the processes of the organization, and the enabled automation tools of the organization.

In order to understand enactment in the context of software development it is needed to first look at the operational model under which software development is carried out and investigate how governance mechanisms can influence or interact with those model elements.

Consider an operational model in development environments. An operational model is a model that describes how an organization operates. In the context of software development, a metamodel for specifying software engineering processes provides, for example, several key constructs: work definition, work products and responsibility assignments. Work definition comprises describing tasks, steps, and activities or, in general, how work should be performed. Work products comprises describing both tangible and intangible work products that are required either as input to performing a work step or are the output of doing the work. Responsibility assignments comprise describing the responsibilities that different roles have in carrying out the work.

Many organizations and projects organize their work in a less formalized manner or need a lower level of ceremony for their processes. For example, it may suffice for some development teams to simply specify the roles and responsibilities on the team, major milestones to be achieved, the artifacts that need to be generated, and high level working procedures.

In many cases software engineers use tools to create and evolve the work products that need to be generated. They also use tools to automate, coordinate or orchestrate the work that needs to be carried out.

Consider control and observation points in the development process. The operational model provides the basic building blocks with which the governance solution can interact. Enactment of governance mechanisms means controlling or measuring something within the scope of the operational model. Enactment of the responsibility assignments therefore need to control the interaction of users/roles with elements of the operational model.

Control points are points in the execution of a process to which controls can be applied. Observation points are points in the execution in which some property of an operational model can be observed. These points can be thought of as a kind of junction between the governance solution and the operational model to achieve enactment.

Some examples of governance points in software development environments include: user actions in a tool user interface; work product state transition in an artifact repository, e.g., changing a work item state from in progress to completed; user access to an artifact, e.g., file read by user; work definition events, e.g., milestone/task completed; and other events, e.g., time related events, or external events to the development process.

FIG. 6 shows an artifact life-cycle operational model 600. The artifact life-cycle operational model 600 is one which assigns a state machine to each artifact type and defines activities in terms of state transitions on input and output artifacts, that is, input-output artifacts. In an artifact-lifecycle operational model 600 the control points are the points prior to an artifact transition. Role assignment in this model therefore associates roles with artifact state transitions. In our earlier example, if currDate <codeFreezeDate, a developer can make the decision to deliver the code by transitioning it from in progress to delivered.

The artifact life-cycle operational model 600 of a governed process can be used to guide the governance solution specification. The artifact life-cycle operational model 600 is useful for both governance specification and enactment.

Consider configurability of enactment tools. Enactment requires implementation and execution of the governance specification. It is desirable that enactment tools provide configuration points that enable automation of governance specifications.

Configurability of enactment can be implemented in tools, such as enactment tools, by allowing extensibility code some control of the execution threads, for example: allowing pre-conditions and post actions for an artifact state transition; event based model supporting observations of the governed system; intercepting user interface actions; and configurable access and permission control to business logic, repository or other guarded resource.

Consider tool enablement. Tools are enhanced with support for responsibility assignment. For example, rights-checking code for role assignments with decision rights requirements (like “R”) can present an “advisor” to the user to explain to the user why the governance solution prohibits a given decision. Some decisions require sign-off from another role, e.g., the “A” role. Tool support for sign-off can prompt the role for permission and block until permission is received, or fail if permission is not received. Similarly, a voting workflow can be created for all roles participating in a sign-off activity. A user who is accountable for some activities can also be given rights to view details of the activities for which he has that role. The tool can report on these activities showing status and any other metrics of interest. This can include information about whether the “C” and “I” roles were in fact consulted and informed at some point during the activity. To support the required communication, when there is instant messaging support, a messaging group can be displayed with the other roles (“C”, “I”, “A”). Or if there is email support, an email list can be created to facilitate the communication.

Almost all aspects of the development process are configurable within a software platform of the invention, specifically the configuration and control of an operational model using customizable process specification views. For example, the software platform allows projects to be broken up into separate teams, each with their own areas of responsibility. Team members can be assigned roles which are defined when the team area is created. Each component's behavior can be configured for various roles performing their work. Permissions settings can be viewed as a limited form of a role decision right assignment.

An operation has preconditions which are checked before the operation is executed. An example precondition is that there are no compilation errors in the workspace prior to code delivery. An overruling attribute indicates that the precondition can be overruled by the user delivering the code. If the user attempts to deliver code with compilation errors an advisor dialog notifies them of the violation.

The software platform allows configuration of additional aspects of an operational model such as the work item types and their workflows (lifecycles). Customizable extensible-markup-language based configuration allows definition of the operational model for common work-item types and their transitions (defect repair, task, enhancement, etc.) which can be manipulated.

Besides configuring and controlling work-items, the software platform provides programmable application programming interfaces (APIs) that allows defining the operational model for other types of artifacts or user operations and the relevant control and observations points that impact its behavior.

The software platform provides advisor, participant, configuration data and event configuration points. The advisors configuration point is run prior to an operation. The advisor configuration points have enables to control the execution flow, e.g., precondition checking. The participant configuration points are run after the operation and allow execution of additional logic, e.g., take a measurement. The configuration data configuration points are enabled to provide XML-based input to a component in the software platform. The event configuration points allow components on the server to register to server based events.

The software platform provides the necessary building blocks and plumbing to define and control the operational model and provides a full governance enactment solution. In particular, the software platform supports RACI roles and responsibilities and enforces and tracks them in team interactions. Furthermore, platform APIs allow a user to develop custom code that can implement this type of feature. Easy configuration of governance solutions is enhanced by XML-based customizable support for other types of governance mechanisms such as policy enforcement, performance measurement, process feedback, etc. Finally, the platform enforcement of decision rights, via advisors, is performed with respect to component operations and state transitions on artifacts.

FIG. 7 illustrates a computer system 700 in accordance with which one or more components/steps of the techniques of the invention may be implemented. In an embodiment, the computer system 700 is adapted to execute at least part of a method of the invention, for example, at least part of the method, illustrated in FIG. 2, comprising defining a governance solution, implementing the governance solution, executing the governance solution and assessing the governance solution. Implementing the governance solution comprises designing the solution and providing the solution to the governed organization. A software system is adapted to the defining, the implementing, the executing, and the assessing of the governance solution. In another embodiment, the computer system 700 comprises a memory 710 and a processor 705 coupled to the memory and configured to define a governance solution, implement the governance solution, execute the governance solution, and assess the governance solution. Implementing the governance solution comprises designing the solution and providing the solution to the governed organization. A software system is adapted to defining, implementing, executing, and assessing of the governance solution. In yet another embodiment, the computer system 700 is adapted to execute at least part of a software system shown in FIG. 1. The software system comprises a governance solution model 110 component operative to provide at least one definition and at least one semantic of at least one governance entity and a relationship of the at least one governance entity to an operational model of an organization, a governance solution editor 120 operative to specifying a governance solution by forming a governance specification, a governance solution bundle 140 operative to provide packaging of the governance specification into a package that can be deployed and enacted, a governance solution enactment component 130 operative to deploy the governance solution into an organizational context, a process enactment tool 150 operative to provide at least one configuration point, and a governance lifecycle component 160 operative to provide a first view into a state of the governance solution.

It is to be further understood that the individual components/steps of the invention may be implemented on one such computer system or on more than one such computer system. In the case of an implementation on a distributed computing system, the distributed computer system may comprise one or more computer systems implementing aspects of the invention. The individual computer systems and/or devices may be connected via a suitable network, e.g., the Internet or World Wide Web. However, the system may be realized via private or local networks. In any case, the invention is not limited to any particular network. Thus, the computer system shown in FIG. 7 may represent one or more servers, or one or more other processing devices capable of providing all or portions of the functions described herein.

The computer system may generally include a processor unit 705, memory 710, input/output (I/O) devices 715, and network interface 720, coupled via a computer bus 725 or alternate connection arrangement.

It is to be appreciated that the term “processor unit” as used herein is intended to include any processing device, such as, for example, one that includes a central processing unit (CPU) and/or other processing circuitry. It is also to be understood that the term “processor unit” may refer to more than one processing device and that various elements associated with a processing device may be shared by other processing devices.

The term “memory” as used herein is intended to include memory associated with a processor or CPU, such as, for example, random access memory (RAM), read only memory (ROM), a fixed memory device (e.g., hard disk drive), a removable memory device (e.g., diskette, compact disk, digital video disk or flash memory module), flash memory, non-volatile memory, etc. The memory may be considered a computer readable storage medium.

In addition, the phrase “input/output devices” or “I/O devices” as used herein is intended to include, for example, one or more input devices (e.g., keyboard, mouse, camera, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Accordingly, application components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

In any case, it is to be appreciated that the techniques of the invention, described herein and shown in the appended figures, may be implemented in various forms of hardware, application, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A software system for governance, the system comprising:
a governance solution model component operative to provide at least one definition and at least one semantic of at least one governance entity, and a relationship of the at least one governance entity to an operational model of an organization;
a governance solution editor operative to specifying a governance solution by forming a governance specification;
a governance solution bundle operative to provide packaging of the governance specification into a package that can be deployed and enacted;
a governance solution enactment component operative to deploy the governance solution into an organizational context;
a process enactment tool operative to provide at least one configuration point; and
a governance lifecycle component operative to provide a first view into a state of the governance solution.

2. The system of claim 1, wherein the at least one governance entity comprises at least one of a governance goal, a governance scope, a governance body, a governance policy, a governance control and a governance measure.

3. The system of claim 1, wherein the operational model comprises at least one of a process, an artifact, a state transition and a user operation.

4. The system of claim 1, wherein the governance solution enactment component is further operative to specify a software tool and a server for enactment of the governance solution, wherein the governance solution enactment component is operative to provide a schedule for enactment of the governance solution, and wherein the governance solution enactment component is operative to deploy the governance solution bundle.

5. The system of claim 1, wherein the governance solution bundle is further operative to provide at least one parameter that can be exchanged between the governance specification and the enactment tool, and wherein the governance solution bundle is further operative to provide a packaging format for providing the governance specification to an enactment tool.

6. The system of claim 1, wherein the at least one configuration point provides at least one extension point for at least one of custom code, and configuration to control an execution processes.

7. The system of claim 1, wherein the governance solution is enacted across lifecycle phases, the lifecycle phases comprising defining, assessing, implementing and executing the governance solution.

8. The system of claim 1, wherein the state comprises at least one of a runtime states, a history, a status, and an issues, and wherein the first view comprises at least one of a view into the organization, a dashboard to assess progress towards governance goals, and an alert requiring governance attention.

9. The system of claim 1, wherein the governance is at least one of governance of an information technology organization and governance of software development.

10. The system of claim 1, wherein the governance solution comprises a set of governance mechanisms comprising at least one of a decision right, a policy, a control, a measurement, and a role assignment comprising a role and a responsibility of the role for a decision-making processes, and wherein the set of governance mechanisms is applied to a governance scope in order to achieve a governance goal.

11. The system of claim 10, wherein a governance point represents a specified situation within the governance scope to which the governance mechanism is applied.

12. The system of claim 10, wherein the set of governance mechanisms comprises at least one of a measure of estimated time to perform a tasks versus the actual time to perform the task, a measure of productive work per iteration through lifecycle phases, and assessing a past iteration though the lifecycle phases before planning a next iteration through the lifecycle phases, and wherein the lifecycle phases comprise defining, assessing, implementing and executing the governance solution.

13. The system of claim 2, wherein the governance scope comprises a set of entities and relationships that is subject to acts of governance, wherein the governance body comprises a set of roles that has a right to exercise authority over the governance scope, and wherein the governance goal comprises a desired state that the acts of governance are trying to achieve within the governance scope.

14. The system of claim 1, wherein the governance solution has relationship with an additional governance solution through governance mechanisms that affects the governance solution and the additional governance solution.

15. The system of claim 1, wherein extensibility code has at least partial control over an execution thread within the software system.

16. The system of claim 1 further comprising:
a user interface adapted to present a second view to at least one role, wherein a governance body comprises the at least one role, and wherein the at least one role has a right to exercise authority over a governance scope;
a data module comprising a database and a data adapter, wherein the database adapter is adapted to mediate between an application and the database, and wherein the database comprises at least one of a software development artifact, a software management artifact, an activity indicator, governance mechanisms and a governance observable; and
a scheduler adapted to scheduling tasks for the governance mechanisms, wherein the governance solution comprises the governance mechanisms.

17. The system of claim 1 further comprising:
an artifact life-cycle operational model comprising assignment of at least one state machine to at least one artifact type, the artifact life-cycle operational model further comprising at least one activity comprising at least one state transition on at least one input-output artifact, wherein at least one control point is prior to the at least one state transition, and wherein role assignment associates roles with the at least one state transitions.

18. The system of claim 1 further comprising:
a programmable application programming interface adapted to defining the operational model and adapted to custom code development.

19. The system of claim 1, wherein the system is adapted to provide customizable extensible-markup-language support for governance mechanisms, and wherein the system is adapted to provide customizable extensible-markup-language based configuration.

20. The system of claim 1, wherein the at least one configuration point comprises at least one of an advisor configuration point, a participant configuration point, a configuration data configuration point and an event configuration point, wherein the advisor configuration point has enables to control an execution flow, wherein the participant configuration point allows execution of a logic operation, and wherein the configuration data configuration point is enabled to provide extensible-markup-language-based input to a component in the system.

21. A method for governance, the method comprising the steps of:
defining a governance solution;
implementing the governance solution, wherein implementing the governance solution comprises designing the solution and providing the solution to the governed organization;
executing the governance solution; and
assessing the governance solution, wherein a software system is adapted to the defining, the implementing, the executing, and the assessing of the governance solution.

22. The method of claim 21 further comprising the step of:
correcting the governance solution in response to the assessing.

23. The method of claim 21, wherein the software system comprises:
a governance solution model component operative to provide at least one definition and at least one semantic of at least one governance entity, and a relationship of the at least one governance entity to an operational model of the governed organization;
a governance solution editor operative to specifying the governance solution by forming a governance specification;
a governance solution bundle operative to provide packaging of the governance specification into a package that can be deployed and enacted;
a governance solution enactment component operative to deploy the governance solution into the context of the governed organization;
a process enactment tool operative to provide at least one configuration point; and
a governance lifecycle component operative to provide a view into a state of the governance solution.

24. An article of manufacture for governance, the article comprising a computer readable storage medium having one or more programs embodied therewith, wherein the one or more programs, when executed by a computer, perform the steps of:
defining a governance solution;
implementing the governance solution, wherein implementing the governance solution comprises designing the solution and providing the solution to the governed organization;
executing the governance solution; and
assessing the governance solution, wherein a software system is adapted to the defining, the implementing, the executing, and the assessing of the governance solution.

25. A computer resource for governance, the computer resource comprising:
a memory; and
a processor coupled to the memory and configured to:
define a governance solution;
implement the governance solution, wherein implementing the governance solution comprises designing the solution and providing the solution to the governed organization;
execute the governance solution; and
assess the governance solution, wherein a software system is adapted to defining, implementing, executing, and assessing of the governance solution.
